(19) United States
(12) Patent Application Publication
(10) Pub. No.: US 2007/0229937 A1
(43) Pub. Date: Oct. 4, 2007

(54) Inexpensive terahertz wave generator

(76) Inventor: Lothar Benedict Erhard Josef Moeller, Middletown, NJ (US)

Correspondence Address: Lucent Technologies Inc.;Docket Administrator - Room 3J-219, 101 Crawfords Corner Road, Holmdel, NJ, 07733-3030, US

(21) Appl. No.: 11/396,185

(22) Filed: Mar. 31, 2006

(51) Int. Cl. G02F 1/35; G02F 2/02

(52) U.S. Cl. 359/326

(57) ABSTRACT

Terahertz waves are generated by modulating the output of a cw laser to produce an optical signal with equally spaced frequency components. The modulated optical signal is supplied to a nonlinear optical waveguide in which it undergoes self-phase modulation, thereby producing at least two further frequency components that are separated by a desired frequency in the terahertz gap and have a sufficient magnitude. An optical filter selects the two frequency components, which are directed to a photomixer, that produces an electrical signal with the same frequency as the beat frequency. The photomixer is biased, and coupled to an antenna, so that the resulting electrical signal causes an electromagnetic wave having a frequency in the terahertz range to propagate from the antenna.

### TECHNICAL FIELD

This invention relates to the generation of electromagnetic waves in the terahertz frequency range.

### BACKGROUND OF THE INVENTION

Continuous wave generators that generate signals in the so-called “terahertz region”, which is also known as the “terahertz gap”, e.g., between 300 gigahertz and 10 terahertz, are useful for various applications, e.g., spectrum analyzer applications. Prior art terahertz wave generators employed two continuous wave lasers with a frequency difference between them in the terahertz range. The two lasers were combined using an optical coupler or a beam combiner to produce a single beam with a beat frequency equal to the difference between the two laser beams, i.e., with a beat frequency in the terahertz range. The single beam was then directed to a photomixer, which responded to the input optical signal to produce an electrical signal with the same frequency as the beat frequency. The photomixer is biased, and coupled to an antenna, so that the resulting electrical signal causes an electromagnetic wave having a frequency in the terahertz range to propagate from the antenna.

Disadvantageously, the use of two lasers is unduly expensive. Also, it is very difficult to get the two lasers to match precisely in order to produce a terahertz wave with small frequency fluctuations, especially over time, given that as it operates each laser tends to drift somewhat in frequency.

Another prior art approach to generating a continuous terahertz wave is to employ a mode-locked laser that generates a periodically modulated signal having a carrier frequency that is much higher, e.g., in the vicinity of 200 terahertz, than the modulation rate, which is typically between 10 and 40 gigahertz. The modulation rate that results is typically that of a radio frequency (RF) signal. The modulated signal is supplied as an input to the mode-locked laser. The resulting output signal is represented in the frequency domain as a comb signal, with the comb teeth representing frequency components within the signal having a frequency spacing equal to the modulation rate. A filter is employed to select two of the frequency components with a desired spacing, e.g., a spacing of a magnitude that is within the terahertz gap. This difference corresponds to the beat frequency of the selected frequency components. The selected frequency components are directed to a photomixer, which responds to the input selected frequency components to produce an electrical signal with the same frequency as the beat frequency between them. The photomixer is biased, and coupled to an antenna, so that the resulting electrical signal causes and electromagnetic wave having a frequency in the terahertz range to propagate from the antenna.

Disadvantageously, each mode-locking laser is designed for a single particular mode-locking frequency, which may only be varied by a small amount. Thus, the mode-locked laser cannot be easily tuned to any desired modulation frequency, because the frequency of the RF signal must be within the mode-locking range of the laser.

### SUMMARY OF THE INVENTION

I have recognized that the generation of terahertz waves can be improved, in accordance with the principles of the invention, by generating optical frequency components that have a beat frequency in the terahertz gap using a continuous wave (cw) laser, a modulator coupled to the output of the cw laser, and a nonlinear optical waveguide coupled to the output of the modulator. More specifically, the cw laser output signal is modulated by the modulator to produce an optical signal with equally spaced frequency components, i.e., a comb frequency spectrum, but not necessarily of equal magnitude. The modulator may employ a radio frequency signal, e.g., typically between and 100 GHz, as the modulating signal. The modulated optical signal is supplied to the nonlinear optical waveguide in which it undergoes self-phase modulation (SPM). As a result, at least two further frequency components are produced that are separated from each other by a desired frequency in the terahertz gap and have a sufficient magnitude. Note that the separation between the two further frequency components is a multiple of the frequency of the modulating signal. Thereafter, an optical filter then selects the two frequency components, which are directed to a photomixer, that responds to the selected frequency components to produce an electrical signal with the same frequency as the beat frequency, i.e., the difference in frequency, between them. The photomixer is biased and, optionally, coupled to an antenna. If so, the resulting electrical signal causes an electromagnetic wave having a frequency in the terahertz range to propagate from the antenna.

Advantageously, inexpensive cw lasers that are typically used for telecommunications applications, e.g., cw lasers at 1.5 μm and 1.3 μm, and conventional electroabsorption modulators may be employed, thereby resulting in an overall low system cost.

### BRIEF DESCRIPTION OF THE DRAWING

In the drawing:

FIG. 1 shows an exemplary arrangement for generating terahertz waves in accordance with the principles of the invention; and

FIG. 2 shows an improved version of the arrangement of FIG. 1 for generating terahertz waves in accordance with the principles of the invention.

### DETAILED DESCRIPTION

The following merely illustrates the principles of the invention. It will thus be appreciated that those skilled in the art will be able to devise various arrangements that, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown.

The functions of the various elements shown in the FIGs., including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared.

In the claims hereof any element expressed as a means for performing a specified function is intended to encompass any way of performing that function. This may include, for example, a) a combination of electrical or mechanical elements which performs that function or b) software in any form, including, therefore, firmware, microcode or the like, combined with appropriate circuitry for executing that software to perform the function, as well as mechanical elements coupled to software controlled circuitry, if any. The invention as defined by such claims resides in the fact that the functionalities provided by the various recited means are combined and brought together in the manner which the claims call for. Applicant thus regards any means which can provide those functionalities as equivalent as those shown herein.

Unless otherwise explicitly specified herein, the drawings are not drawn to scale. Also, unless otherwise explicitly specified here, all optical elements or systems that are capable of providing specific function within an overall embodiment disclosed herein are equivalent to one another for purposes of the present disclosure.

In the description, identically numbered components within different ones of the FIGs. refer to the same components.

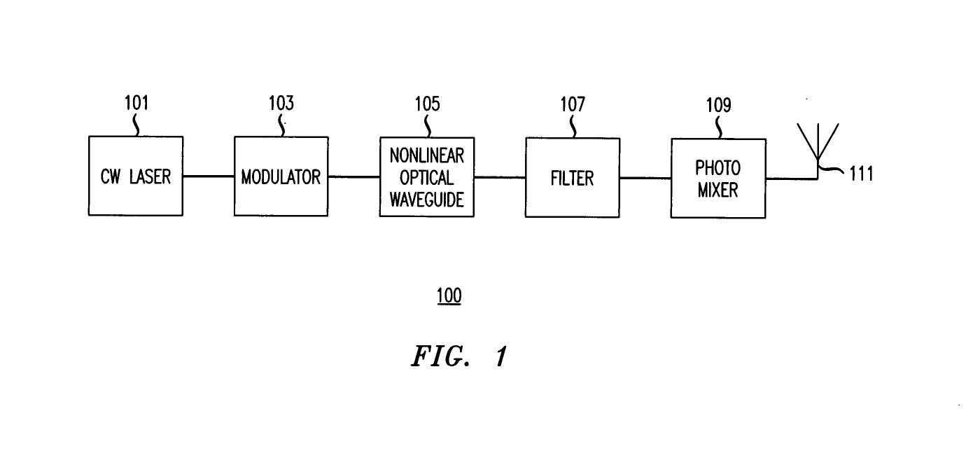

Terahertz waves are generated, in accordance with the principles of the invention, by generating optical frequency components that have a beat frequency in the terahertz gap using a continuous wave (cw) laser, a modulator coupled to the output of the cw laser, and a nonlinear optical waveguide coupled to the output of the modulator. FIG. 1 shows exemplary arrangement 100 for generating terahertz waves in accordance with the principles of the invention. Shown in FIG. 1 are a) cw laser 101, b) modulator 103, c) frequency generator 104, d) nonlinear optical waveguide 105, e) filter 107, f) photomixer 109, and g) antenna 111.

More specifically, cw laser 101 provides a constant output signal at a prescribed wavelength. For example, cw laser 101 may be an inexpensive cw laser such as is typically used for telecommunications applications, e.g., cw lasers at 1.5 μm and 1.3 μm. The output signal from cw laser 101 is modulated by modulator 103 to produce an optical signal made up of short pulses that have equally spaced frequency components, i.e., a comb frequency spectrum, but not necessarily of equal magnitude. Modulator 103 may be a conventional electroabsorption modulator. As is well known to those of ordinary skill in the art, such an electroabsorption modulator is driven by a sinusoidal electrical signal that is generated in the arrangement of FIG. 1 by frequency generator 104. Typically, the pulses output by modulator 104 are repeated with the same frequency as that of the sinusoidal signal. Advantageously, a lower overall system cost may be achieved by a) implementing cw laser 101 using a conventional inexpensive cw laser, such as is typically used for telecommunications applications and b) implementing modulator 103 using a conventional electroabsorption modulator.

The modulated optical signal output by modulator 104 is supplied to nonlinear optical waveguide 105, in which it undergoes self phase modulation (SPM). As a result, at least two further frequency components are produced that 1) are separated by a desired frequency in the terahertz gap and 2) have a sufficient magnitude. Note that the separation between the two further frequency components is a multiple of the frequency of the modulating signal supplied by frequency generator 104.

Thereafter, optical filter 107 selects the two desired frequency components and directs them to photomixer 109. Photomixer 109 may be a so-called Auston switch.

Preferably, each of the selected frequency components has approximately the same power, in order to maximize the efficiency of photomixer 109. Also, preferably, optical filter 107 selects the two frequency components such that they have essentially the same polarization. If the selected frequency components do not have similar polarization, their interaction in photomixer 109 will be reduced. Indeed, if the selected frequency components are orthogonal, no interaction will occur, and hence photomixer 109 will not produce any signal. To achieve selection of frequency components that have essentially the same polarization, optical filter 107 may include at least one polarization controller, which can change the polarization of selected light to a desired polarization.

Photomixer 109 responds to the selected frequency components by producing an electrical signal with the same frequency as the beat frequency, i.e., the difference in frequency, between the two selected frequency components. To this end, photomixer 109 may be biased, e.g., with a continuous voltage. The output of photomixer 109 may be coupled to an antenna, e.g., antenna 111, so that the resulting electrical signal causes an electromagnetic wave having a frequency in the terahertz range to propagate from antenna 111, e.g., radiated into space. Alternatively, the resulting electrical signal may be captured by a focusing device, e.g., a lens or an antenna, and supplied to a waveguide, e.g., in order to contain the terahertz waves that are produced on a chip.

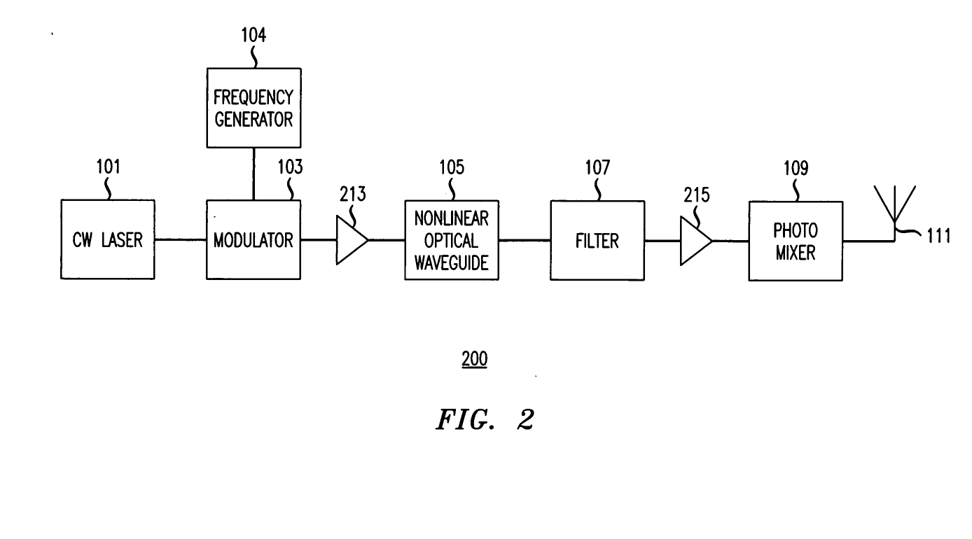

FIG. 2 shows exemplary arrangement 200, which is an improved version of arrangement 100, for generating terahertz waves in accordance with the principles of the invention. In addition to a) cw laser 101, b) modulator 103, c) nonlinear optical waveguide 105, d) filter 107, e) photomixer 109, and f) antenna 111 of arrangement 100, arrangement 200 of FIG. 2 further includes optical amplifiers 213 and 215. Optical amplifier 213 amplifies the output of modulator 103. By increasing the amplitude of the signal supplied to nonlinear optical waveguide 105, the operation of nonlinear optical waveguide 105 is improved, in that the nonlinear effect of nonlinear optical waveguide 105 is strengthened, so that a) the frequency components that are produced have a higher magnitude than they would have had had the amplification not been performed and b) the frequency comb produced is wider. Optical amplifier 215 amplifies the output of filter 107, i.e., it amplifies the components selected by filter 107. In addition to increasing the magnitude of each of the selected components, optical amplifier 215 may be arranged to amplify one component more than the other in order to equalize the strengths of the components. Doing so may be desirable since the efficiency of photomixer 109 is typically maximized when the frequency components supplied to it have approximately the same power.

1. Apparatus, comprising:
a continuous wave (cw) laser;
a modulator coupled to an output of said cw laser; and
a nonlinear optical waveguide coupled to an output of said modulator.

2. The invention as defined in claim 1 wherein said nonlinear optical waveguide cause a wave input thereto to undergo self phase modulation.

3. The invention as defined in claim 1 wherein said nonlinear optical waveguide is adapted to supply as an output at least a plurality of frequency components, said apparatus further comprising an optical filter adapted to select and supply as an output two of said plurality of frequency components that have a prescribed frequency spacing between them.

4. The invention as defined in claim 3 further comprising an amplifier adapted to amplify said output of said optical filter and to supply as an output an amplified version of said output of said optical filter.

5. The invention as defined in claim 3 further comprising an amplifier adapted to adjust at least one of said selected frequency components so that the amplitude of said selected frequency components is substantially the same and to supply as said amplitude adjusted frequency components as an output.

6. The invention as defined in claim 3 further comprising a polarization controller adapted to adjust at least one of said selected frequency components so that the polarization of said selected frequency components is substantially the same and to supply said polarization matched frequency components as an output.

7. The invention as defined in claim 3 further comprising a photomixer coupled to said optical filter.

8. The invention as defined in claim 7 wherein said photomixer is responsive to said selected frequency components to produce an electrical signal having a frequency corresponding to a difference in frequency between said selected frequency components.

9. The invention as defined in claim 7 wherein said photomixer is an Auston switch.

10. The invention as defined in claim 7 wherein said photomixer is coupled to an antenna.

11. The invention as defined in claim 7 wherein said photomixer is a photoconducting antenna.

12. The invention as defined in claim 7 wherein said photomixer produces a signal in the terahertz gap range.

13. The invention as defined in claim 7 wherein a bias is applied to said photomixer.

14. The invention as defined in claim 13 wherein said bias is a constant voltage.

15. The invention as defined in claim 1 wherein said cw laser produces a signal that has a wavelength of 1.5 Mm.

16. The invention as defined in claim 1 wherein said cw laser produces a signal that has a wavelength of 1.3 Mm.

17. The invention as defined in claim 1 wherein said modulator is an electroabsorption modulator.

18. The invention as defined in claim 17 further comprising a frequency generator adapted to supply a sinusoidal control signal to said electroabsorption modulator.

19. The invention as defined in claim 1 further comprising an amplifier adapted to amplify the output of said modulator and to supply an amplified version of said output of said modulator to said nonlinear optical waveguide.

20. A method for developing terahertz waves comprising the steps of:
modulating an output of a constant wavelength (cw) laser to produce a modulated optical signal; and
self modulating a version of said modulated optical signal to produce at least two frequency components that have a desired frequency spacing between them in the terahertz range.

21. The invention as defined in claim 20 wherein said modulated optical signal is self modulated in a nonlinear optical waveguide.

22. The invention as defined in claim 20 further comprising the step of amplifying said modulated optical signal to produce an amplified version thereof, wherein said version of said modulated optical signal that is self modulated in said self modulating step is said amplified version.

23. The invention as defined in claim 20 further comprising the steps of:
selecting said two frequency components; and
supplying a version of said selected frequency components to a photo mixer.

24. The invention as defined in claim 23 further comprising the step of amplifying at least one of said selected frequency components, so that said version of said selected frequency components supplied to said photo mixer includes at least one amplified frequency component.

25. The invention as defined in claim 23 further comprising the step of adjusting the polarity at least one of said selected frequency components, so that said version of said selected frequency components supplied to said photo mixer includes at least one polarity adjusted frequency component.

26. The invention of claim 20, wherein:
the step of modulating comprises intensity modulating the output of the cw laser at a modulating frequency supplied by a frequency generator.

27. The invention of claim 26, wherein:
the step of self modulating comprises subjecting the modulated optical signal to self-phase modulation to generate first and second frequency components that are separated by an integer multiple of the modulating frequency.

28. The invention of claim 27, further comprising:
selecting the first and second frequency components with a filter;
in a photomixer responsive to the first and second frequency components, generating a signal having a frequency corresponding to the frequency separation between the first and second frequency components.

29. The invention of claim 1, wherein:
the modulator is an intensity modulator adapted to modulate the output of the cw laser at a modulating frequency supplied by a frequency generator.

30. The invention of claim 29, wherein:
the nonlinear optical waveguide is adapted to subject the output of the modulator to self-phase modulation to generate first and second frequency components that are separated by an integer multiple of the modulating frequency.

31. The invention of claim 30, further comprising:
a filter adapted to select the first and second frequency components and apply said selected components to a photomixer; and
the photomixer adapted to, in response to the applied first and second frequency components, generate a signal having a frequency corresponding to the frequency separation between said components.
